(19) United States
(12) Patent Application Publication
(10) Pub. No.: US 2010/0186889 A1
(43) Pub. Date: Jul. 29, 2010

(54) VACUUM BAGGING METHODS AND SYSTEMS

(75) Inventors: Michael D. Kipp, Provo, UT (US); Michael D. Ridges, American Fork, UT (US); William McCarvill, Salt Lake City, UT (US)

Correspondence Address: THORPE NORTH & WESTERN, LLP., P.O. Box 1219, SANDY, UT, 84091-1219, US

(73) Assignee: American Consulting Technology & Researc Inc.

(21) Appl. No.: 12/647,130

(22) Filed: Dec. 24, 2009

Related U.S. Application Data
(63) Continuation of application No. 11/418,850, filed on May 5, 2006, now abandoned.
(60) Provisional application No. 60/678,691, filed on May 6, 2005.
(60) Provisional application No. 60/753,608, filed on Dec. 22, 2005.

(51) Int. Cl. B32B 38/10; B32B 37/02

(52) U.S. Cl. 156/247; 156/285; 156/349

(57) ABSTRACT

Vacuum bagging methods and systems are provided for lay-ups of pre-impregnated composite materials. Generally, the methods and systems of the present invention provide for applying a sealing layer of resin over a release layer, which is on a lay-up of pre-impregnated reinforcement composite materials.

### PRIORITY CLAIMS

This application is a continuation of U.S. application Ser. No. 11/418,850, filed May 5, 2006, entitled, “Vacuum Bagging Methods and Systems,” which claims the benefit of U.S. Provisional Application Ser. No. 60/678,691, filed May 5, 2005, entitled “Vacuum Bagging Methods and Systems,” and of U.S. Provisional Application Ser. No. 60/753,608, filed Dec. 22, 2005, entitled “Vacuum Bagging Methods and Systems,” each of which are incorporated by reference in their entirety herein.

### THE FIELD OF THE INVENTION

The present invention is drawn towards methods and systems for enhancing sealing performance or vacuum integrity of a vacuum bagging system. In particular, the invention is related to utilizing a sealing layer of resin to enhance the sealing performance or vacuum integrity of a vacuum bagging system.

### BACKGROUND OF THE INVENTION

Developing composite parts having high strength and lightweight has been a focus in many industrial fields in recent years. In particular, the aerospace industry has focused on fabricating various composite parts (e.g. fuselage, wings) to be used in the manufacturing of airplanes.

Many approaches have previously been developed for forming composite parts that exhibit light weight and structural integrity. Most processes, utilized in forming composite members, require multiple steps or sub-processes to achieve a composite member. One such sub-process is a vacuum bagging process where multiple layers of composite material are formed into a desired shape and thus forming a desired product. A typical vacuum bagging process involves placing individual layers of material onto a mold having the desired shape. Traditional vacuum bagging methods initially places a “release layer” onto a mold surface. The release layer reduces the bonding of the composite member with the mold surface and thus enables an easy removal. A “prepreg member”, (short for pre-impregnated reinforcement fabrics and/or fibers member), provides the structure and reinforcement for the composite member. The prepreg is either a dry or wet lay-up prepreg component. The dry lay-up is typically a pre-formed structure partially formed prior to placing onto the release layer, while a wet lay-up consists of placing a fabric or fibers onto the release layer. A liquid epoxy composition is subsequently poured onto the fibers to impregnate the fibers. A partial curing step may be applied to the prepreg member where necessary. Further, a second release layer and a breather/bleeder layer are typically disposed onto the prepreg member, respectively, in a traditional vacuum bagging process. Following the composite lay-up, a vacuum bag is placed over the mold encasing the multiple lay-up component parts. The vacuum bag is then placed into an autoclave where the multiple lay-up is processed to form the composite part with application of heat, negative vacuum pressure and external pressure. The vacuum bag and components typically remain in the autoclave until the new composite member is fully cured.

The aforementioned process inherently contains many disadvantages, including extensive preparation time and complexity. Generally, many qualified trained technicians will spend several days laying up the components parts. Most often, the desired shape contains various contours in the design. As the individual layers are applied to the mold surface the technician is careful in removing any voids or gaps that occur in the contours of the desired shape. For example, a section of a fuselage section may contain several folds and corners. A technician will spend extra time laying up the material in the corners and folds to ensure that the process is absent of voids and gaps prior to applying any addition layers. Consequently, the laying up process can take a crew of technicians several days to prepare a composite part for fabrication. Even when the initial technical team has completed the preliminary lay-up process a quality control team must reexamine the lay-up product and verify that system is absent of voids or faulty joints. Failure to remove air pockets, voids, faulty joints or seams can result in weak composite structures which can compromise the structural integrity and aesthetic properties of the composite member. Other equally complex methods have been implemented in an effort to reduce the possibility of structural integrity failure by overlaying material on protrusions and grooves. These methods, however, incur material waste and require more hours of preparation work.

Previously developed methods for forming composite parts also tend to have vacuum bag integrity failure coupled with inadequate vacuum seal for compression of the component materials. In a conventional vacuum bagging process this vacuum bag integrity failure is unpredictable due to the stress and strain posed by contours in the lay-up process. Others have tried to overcome these disadvantages and failures by applying an abundant amount of tape and adhesive glues at the junctions, seams, folds, and crevices to fortify the vacuum bag and seal potential leaks. In addition, these previous processes tend to have a high rate of producing composite parts exhibiting many imperfections. As a result, an increase in material waste is promoted by the previous processes.

Another disadvantage stemming from previous vacuum bagging practices centers around the service life of the forming tool. Generally, the forming tool is susceptible to deterioration, being worn and damaged during the vacuum bagging process. Typically, a tool is discarded and replaced once it develops cracks or imperfections, and thus loses its vacuum integrity or ability to provide an airtight seal. Such a practice can incur high cost and high volumes of waste.

Therefore, it would be advantageous to provide various methods and systems that reduce material waste, reduce preparation time and improve vacuum bagging sealing performance.

### SUMMARY OF THE INVENTION

It has been recognized that it would be advantageous to develop a more reliable and efficient method and system to overcome the aforementioned disadvantages. The method of the present invention is drawn towards overcoming these short comings. The method of the present invention involves vacuum bagging composite members. Particularly, the method provides disposing a lay-up of pre-impregnated reinforcement composite materials on a forming tool, disposing a release layer on the lay-up of pre-impregnated reinforcement composite materials, applying a sealing layer of resin over the release layer, and curing the sealing layer of resin.

In accordance with another embodiment of the present invention a composite member vacuum bagging assembly is disclosed. The vacuum bagging system may include a forming tool, a lay-up of pre-impregnated reinforcement composite materials on the forming tool, a release layer on the lay-up of pre-impregnated reinforcement composite materials, and a cured sealing layer of resin over the release layer.

Additional features and advantages of the invention will be apparent from the detailed description and figures which illustrates, by way of example, features of the present invention.

### BRIEF DESCRIPTION OF THE DRAWINGS

FIG. 1 is a partial graphic cross-section of an embodiment of a vacuum bagging system according to the present invention.

FIG. 2 is a similar diagram of another embodiment of a vacuum bagging system according to the present invention.

FIG. 3 is a similar diagram of another embodiment of a vacuum bagging system according to the present invention.

FIG. 4 is a flow diagram depicting a method for enhancing sealing performance of a vacuum bagging system.

### DETAILED DESCRIPTION OF THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features, process steps, and materials illustrated herein, and additional applications of the principles of the inventions as illustrated herein, which would occur to one skilled in the relevant art and having possession of this disclosure, are to be considered within the scope of the invention. It should also be understood that terminology employed herein is used for the purpose of describing particular embodiments only and is not intended to be limiting.

In describing and claiming the present invention, the following terminology will be used.

The singular forms “a,” “an,” and “the” include plural referents unless the context clearly dictates otherwise. Thus, for example, reference to “a polymer” includes reference to one or more of such materials.

The term “about” when referring to a numerical value or range is intended to encompass the values resulting from experimental error that can occur when taking measurements.

The term “prepolymer” or “quasi prepolymer” according to the present invention means a NCO-terminated compound prepared from diisocyanates and polyols with NCO, and composite materials.

The term “prepreg member” is short for “pre-impregnated reinforcement fabrics and/or fibers member”. Prepregs are applicable in a variety of applications, including aerospace, automotive, and recreational products. Generally, prepregs are reinforcement fabrics such as fiberglass, carbon, and mixtures thereof, which receive a resin solution (e.g. epoxy, polyester, etc.) For example, a prepreg may be fabric or foam formed in a honeycomb shape where self-adhesive resin sheets are applied to the outer surface of the honeycomb core structure and partially cured.

The term “lay-up” means a preparation process in which components, layers or plies of reinforcing material or resin-impregnated reinforcement material are applied to the mold surface in preparation for forming composite members.

The term “lay-up member” means a component member primarily formed from any suitable green material used in formation of a composite part. For example the lay-up member may be one of the following components, a first release, a prepreg member, second release layer, or a breather/bleeder layer.

The term “chain extender” means a compound which lengthens the main chain of a polymer molecule causing end-to-end attachments. The chain extender compound can be used to increase the molecular weight of the polymer.

The term “resin” or “thermosetting resin” or “thermosetting sealing resin” means at least two components when mixed any suitable material that hardens into a definite predetermined shape. In the present invention the thermosetting resin is a polyurea/polyurethane resin, however, other resin may be applicable to the present invention, such as polymeric and thermoplastic. The term resin may include derivates, solvates and mixtures thereof.

The term “breather/bleeder” or “breather-bleeder” means a porous layer or membrane which creates an air pathway between the lay-up components and vacuum film layer allowing for the passing of air. The breather/bleeder layer may be independent and separate such as a breather layer. The breather/bleeder layer is generally comprised of a felt type material. In addition, the breather/bleeder layer may absorb any excess resin.

The term “green material” means any uncured or partially cured material utilized in the fabrication of a composite structure.

The term “spray” or “spraying” means to project or propagate the motion of a material towards an object using a spray device. In the present invention, the term refers to dispensing materials from a spray device and causing these to be projected through the air towards a substrate, such as a component of the vacuum bagging system. Spraying may be carried out using any common spraying method known by those skilled in the art. For example, the spraying method may carried out using an airless, aerosol, robotic or other mechanical spray device and associated processes.

The term “vacuum enclosure” means an airtight enclosure provided by a vacuum film or layer, a sealing layer configured to form the enclosure, a vacuum film and sealing layer combination and/or a vacuum film layer having a sealing layer pre-applied thereto.

The presently claimed invention is drawn towards systems and methods for enhancing the sealing performance of a vacuum bagging system. Generally, the method of the present invention utilizes several steps to enhance the seal performance of a vacuum bagging system. For example, the method may include the steps of i) assembling components of a vacuum bagging system which include at least a forming tool, a prepreg lay-up of composite materials, and a vacuum enclosure; ii) applying a sealing layer of resin on at least one vacuum bagging component; and iii) curing the sealing layer which can be configured to improve the seal integrity of the vacuum bagging system. In accordance with this method, the resin applied is a thermosetting resin or thermosetting sealing resin configured to produce an air tight seal upon curing. In another embodiment the resin may be a polymeric or thermoplastic resin.

In another embodiment, the present invention is drawn towards a vacuum bagging system with enhanced sealing performance. The system includes a forming tool having a working surface and a lay-up member which can be applied to at least a portion of the working surface. In addition, a vacuum layer can be applied to the lay-up member, thereby forming a vacuum enclosure about the lay-up member. In one aspect the vacuum layer may be a vacuum film. Further, a sealing layer of resin can be applied onto at least the forming tool, lay-up member or vacuum layer, or any combination of these. A vacuum port can be in communication through the vacuum layer with the lay-up member, thus providing an air passage where air may be withdrawn and the pressure inside the enclosure may be reduced. In one embodiment the vacuum enclosure may be formed of the same material as the sealing layer. The first resin layer applied to the lay-up member can form the vacuum layer and thus form a vacuum enclosure. One or more additional resin layers can be applied onto the first resin layer and vacuum layer to enhance sealing performance. In this example the additional resin layers actually form the sealing layer. In a general sense, the resin layers form a multi-layer system having enhanced sealing performance according to one embodiment of the present invention.

In an exemplary embodiment of the present invention a vacuum bagging system is provided. The system includes a) a forming tool including a working surface; b) a lay-up member applied to the working surface, wherein the lay-up member may include: i) a first release layer, ii) a prepreg member applied to the first release layer, wherein the prepreg member may be prepreg green material, iii) a second release layer applied to the prepreg member, iv) a breather/bleeder layer applied to the second release layer; and c) a vacuum layer applied to the lay-up member, wherein the vacuum layer forms a vacuum enclosure; d) a sealing layer of resin applied onto the vacuum layer; and e) a vacuum port in communication through the vacuum layer with the breather/bleeder layer.

Another aspect of the present invention includes a method to increase the seal integrity of a vacuum bagging system for forming composite members. The method provides the steps of i) assembling components of a vacuum bagging system, including at least a forming tool, a prepreg lay-up of composite material applied over the forming tool and a vacuum enclosure surrounding the prepreg lay-up, other components which may be susceptible to failure may also be included in the present step; ii) identifying a component which is susceptible to leakage or failure; iii) applying a sufficient amount of resin on the at least one identified component to increase seal integrity of the identified component; and iv) curing the resin to increase the seal integrity. Assembling components of a vacuum bagging process may be accomplished through various means, however, hand lay-up or machine assembly processes may be the most common means available. Generally, applying a sufficient amount of resin onto the identified component can increase the integrity of the component and reduce the possibility of failure. A non-limiting example of the identified components can be the forming tool, the breather/bleeder layer or the vacuum film layer. The use of such a method can provide a process being more predictable to component and vacuum failure.

In yet another aspect of the present invention a method of vacuum molding composite members is provided. Accordingly, the method includes laying up composite forming material in a forming tool, where the composite forming material is substantially green material; applying a breather/bleeder layer to the composite forming material; disposing a vacuum layer about the breather/bleeder layer to form an enclosure; applying a sealing resin on the enclosure; reducing the pressure inside the enclosure; and curing the composite forming materials and sealing resin to form a composite member.

In still another aspect of the present invention a method for sealing a surface of vacuum bagging system components is disclosed. The method comprises the steps of applying a sealing resin onto an exterior surface of at least one component of the vacuum bagging system selected from a group consisting of: a forming tool, a prepreg lay-up of composite materials covering the forming tool and a vacuum enclosure surrounding the prepreg lay-up; and curing the sealing resin to create a vacuum seal. Accordingly, in one aspect of present invention, the method can be applied to a forming tool having a damaged, cracked or worn surface.

Reference will now be made to the drawings in which the various elements of the present invention will be given numeral designations and in which the invention will be discussed. It is to be understood that the following description is only exemplary of the principles of the present invention, and should not be viewed as narrowing the appended claims.

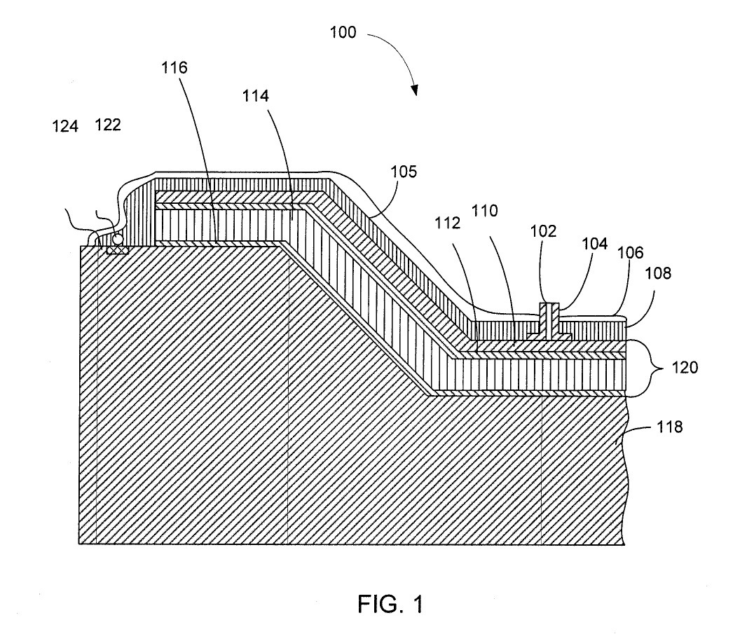

FIG. 1 illustrates a partial cross sectional view of a vacuum bagging system 100 having a forming tool 118 with a lay-up member 120 being applied to the forming tool surface. The lay-up member may comprise any suitable green material used in forming composite parts. In addition, lay-up member may include the following components: (i) a first release layer 116; (ii) an uncured or partially cured prepreg member 114; (iii) a second release layer 112; and (iv) a breather/bleeder layer 110. At least one of these components is applied by a spraying technique. The first release layer is a release layer which may be applied by spraying, brushing, wiping, rolling or any hand laying means to the forming tool surface. Utilizing a first release layer with the present invention facilitates the removal of the cured composite member.

Prepreg member 114 can be sprayed, brushed or hand laid in place and may include a dry lay-up prepreg member or wet lay-up prepreg member. For simplicity the prepreg member of the present invention is a dry lay-up prepreg member. A dry lay-up implies that reinforcement materials have received a resin solution and have been partially formed or cured prior to the vacuum bagging process. A wet lay-up prepreg member involves applying reinforcement material onto the first release layer 116 and disposing an impregnating resin onto the reinforcement material. As noted above, the lay-up member can also include a second release layer 112 which can be positioned between the prepreg member and the breather/bleeder layer 110.

The breather/bleeder layer 110 is generally a porous material which is placed over the second release layer to provide an air or resin pathway when vacuum pressure is applied. Vacuum port 104 is generally in direct contact with or in communication with breather/bleeder layer and can communicate with the breather/bleeder layer through the vacuum layer 108. Vacuum port 104 can be any device or article that allows for connection of communication with a vacuum means, such as a connector, valve or coupling. In addition, vacuum port defines an opening 102 and can be coupled to the vacuum layer 108.

Vacuum layer 108 forms an enclosure (e.g. a bag) such that vacuum pressure may be applied to the uncured composition of the lay-up member, wherein the micro-air pockets can be removed from the lay-up member. Tapes and adhesives, such as heat tape 124 and chromate tape 122 can be used to aid in sealing vacuum layer 108 to the forming tool 118. In addition, vacuum layer 108 can comprise a sealing layer pre-applied thereto.

A sealing layer of resin layer 106 is subsequently applied to the vacuum layer 108, preferably over a primer material 105. The sealing layer 106 is applied using any known application method carried out by any known applicator, such as via spraying using a spray device or applicator, to provide additional vacuum bag integrity and an air tight seal. In one embodiment the sealing layer of resin may be applied onto the vacuum layer resulting in a thickness of 3 mm. In another embodiment the sealing layer of resin may be applied on the vacuum layer having a thickness greater than 3 mm. In still another embodiment, the vacuum enclosure may further comprise a vacuum film layer having a sealing layer pre-applied thereto, which pre-applied vacuum film layer may then be utilized in the vacuum bagging system as known and/or as described herein. In this embodiment,

As discussed below, the resin utilized in the sealing layer can be a thermosetting resin and may be comprised of polyurea and polyurethane compounds. The sealing layer may also a thermoplastic, polymeric or derivatives thereof.

With respect to all embodiments discussed herein, the present invention further contemplates the use of a primer material, which may be applied to or deposited over any one or more of the components configured to receive the sealing layer. In other words, the present invention comprises applying a primer material to the surface of the forming tool component of the vacuum bagging system prior to applying the sealing layer thereto. The primer material provides many benefits, one of which is to facilitate a temporary bond between the sealing layer and the forming tool. The sealing layer, is applied over the primer material, as cured, at elevated temperatures, which elevated temperature functions to activate the primer material. Once applied, the primer material may be allowed to dry to a continuous film. The temporary bond formed functions to facilitate the airtight seal of the vacuum enclosure. However, upon curing and once the composite is formed, the bond may be released and the vacuum enclosure removed.

In a composite lay-up, the vacuum enclosure, whatever its type, may not provide an adequate degree of adhesion to the surface of the forming tool. The primer material functions to improve the adhesion of the vacuum enclosure to the surface of the forming tool. To improve adhesion, the surface of the forming tool may be primed with a primer material prior to applying the sealing layer, such as prior to spraying the sealing layer on the vacuum enclosure (e.g., vacuum film layer). The primer material interacts with the sealing layer and the surface of the forming tool.

The primer material may comprise any number of soft, ductile polymers applied from solvents, dissolved in water, or from dispersions in water, which dispersions are known as polymer latexes. In one exemplary embodiment, the primer material may comprise a polymer applied from water as it has a relatively low environmental impact. Water soluble polymers tend to have glass transition temperatures above 0° C. Although these polymers, such as polyvinyl alcohol, improve adhesion, they are not as effective as those with glass transition temperatures lower than 0° C. The low glass transition temperature polymers may be best applied as latexes. Examples of effective polymers include, but are not limited to, ethylene-vinyl acetate copolymer latexes, such as Air Flex 401, 420 and 426 from Air Chemicals, and acrylic latexes, such as UCAR 1635 from Dow Chemicals. The Air Chemicals latexes can be used as received or where applicable, they can be mixed with catalysts such as sodium bisulfate to induce cross linking, which results in a bond that is more resistant to stresses and strains. Latexes can be blended with water soluble polymers, such as polyvinyl alcohol to increase high temperature adhesion. The primer material can be applied using any known application method, such as by brush, roller or spray device.

Curing the composite member is generally provided by a catalytic reaction from a two component resin composition, an increase in temperature in a range of about 68° F. to about 350° F. and reducing the pressure in a range of about 20 to about 30 inches of mercury inside the enclosure such that the multi-layer green components are compressed and cured to create the composite member. In an alternative embodiment the curing process may be accomplished in an autoclave where the pressure out side of the vacuum bag may be increased to about in a range of about 80 to about 90 pounds per square inch (psi).

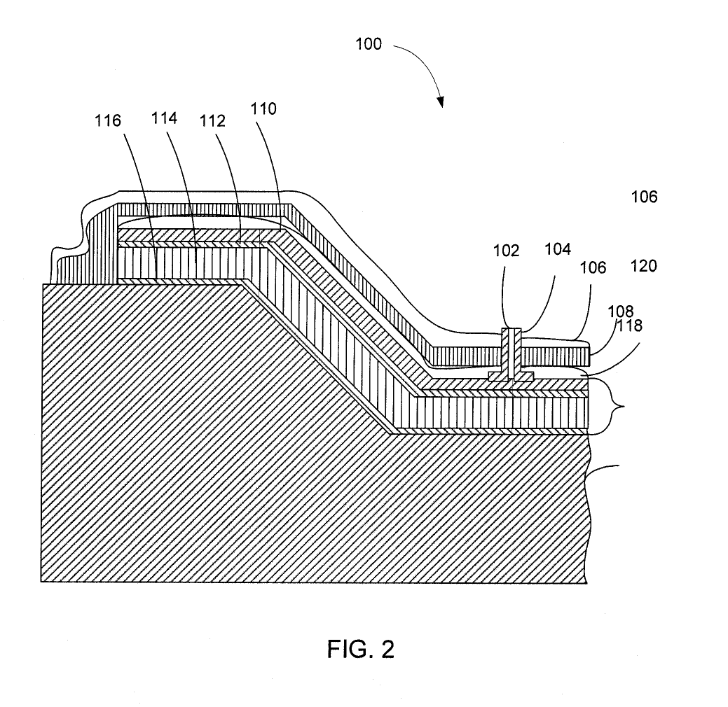

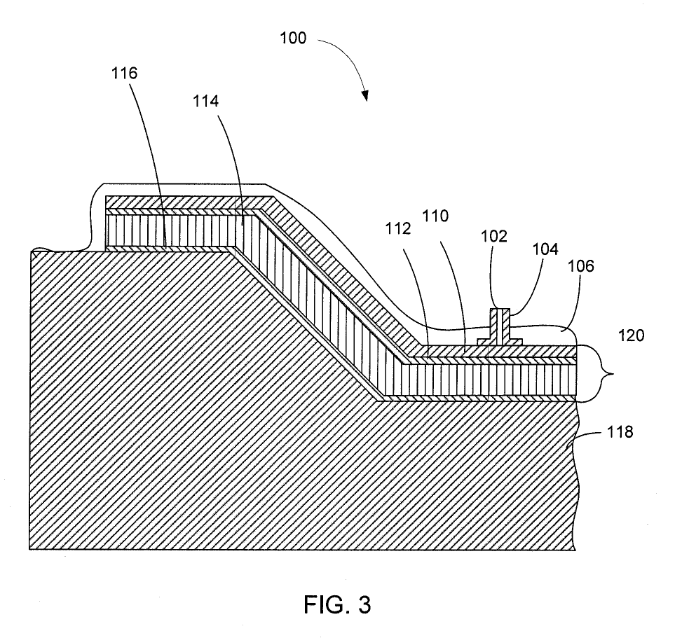

FIG. 2 illustrates an alternative embodiment of the present invention. In FIG. 2 as well as FIGS. 3 the same parts will be identified with the same numbers as previously used. Accordingly, FIG. 2 depicts a composite member being manufactured in a vacuum bagging system having enhanced sealing properties. This process includes the steps of: (i) providing a forming tool 118 having a working surface; (ii) disposing a lay-up member 120 onto the working surface; (iii) disposing a vacuum layer element 108 on the lay-up member where the vacuum forms an enclosure; (iv) applying a sealing layer of resin 106 to at least one of vacuum bagging system's components (i.e. forming tool, breather/bleeder or vacuum layer); (v) reducing the pressure inside the enclosure; and (vi) curing the lay-up member to form the composite member. Sealing layer as noted can be applied to the breather/bleeder layer and/or to the vacuum element in order to provide the vacuum and vacuum seal integrity needed for forming a composite member. In addition, as discussed above, and which discussion is incorporated herein, a primer material may be applied prior to applying the sealing layer.

Forming tool 118 can be pre-fabricated with a substantially flat or contoured surface in the shape of the desired composite part. In one embodiment, forming tool provides a substantially flat working surface. In yet an alternative embodiment the forming tool provides a contoured working surface having corners, curves or surface protrusions. The pre-formed working surface defines the desired shape of the cured composite part. Furthermore, the forming tool may be comprised from various materials such as a metal, ceramic, glass, or a composite material. In addition forming tool may be a porous or non-porous material. In one embodiment the forming tool can be comprised from metallic material.

In accordance with another embodiment of the present invention, forming tool 118 may contain undesirable cracks, pores or grooves that may weaken or otherwise render the forming tool inoperable. The present invention provides a method to seal or repair the damaged or worn forming tool by applying a sealing layer of resin to the forming tool. The resin may be applied onto the external surface of a forming tool having cracks, pores or imperfections. In yet another embodiment the sealing resin may be applied onto a working surface of a forming tool having cracks, pores or imperfections. In still another embodiment the sealing layer may be directly be applied on the crack or pores of a forming tool. In this embodiment the sealing resin may penetrate into the cracks or pores producing a sealed or repaired surface. Once applied and cured, the resin can provided seal integrity to the forming tool rendering the tool operable and reusable for additional processing cycles.

In accordance with the present invention lay-up member 120 can be applied to at least a portion of the working surface of forming tool 118. In accordance with another embodiment the lay-up member may be applied to the entire working surface of the forming tool. Generally, the lay-up member can consist of several green material components. “Green” material, as used herein, refers to composite material which has either been uncured or partially cured. For example, lay-up member may be comprised of (i) a first release layer or liner 116; (ii) a dry or wet lay-up prepreg member 114 applied to the first release layer; (iii) a second release layer 112 applied to the prepreg member; and (iv) a breather/bleeder layer 110 applied to the second release layer. As noted above, at least one of these elements may be sprayed to form the lay-up member. Typically, the release layers are applied by a wiping method however, as will be discussed below, the prepreg member and the breather/bleeder member may be sprayed to form the lay-up member.

In preparation of applying an uncured or partially cured lay-up member 120 onto the forming tool, a first release layer 116 can be disposed between forming tool 118 and prepreg member 114. Disposing first release layer can be accomplished by spraying, brushing, hand laying, wiping or any other suitable means. Generally, first release layer is applied by a wiping method. The composition of first release layer can be a silicone, wax or a variety of polymers. The composition may vary depending on the desired application. In one embodiment the first release layer composition may be a fluoropolymer. In an alternative embodiment the composition of the first release layer may be the same composition as the second release layer. In addition, first release layer can have a thickness in the range of about 0.01 mm to about 1 mm. In particular the first release layer thickness is about 0.01 mm. However, in another embodiment the first release layer can be less than 0.01 mm thick. First release layer can be configured to prevent the prepreg member from bonding or adhering to the working surface of forming tool.

Prepreg member 114 generally provides the structural reinforcement of a composite member. Prepreg member can be a variety of resin impregnated compositions. The term “prepreg” is short for resin pre-impregnated reinforcement fabrics and/or fibers. The prepreg member may comprise of any “green” material, including composites, polymers, plastics, or any other material that utilizes bagging as a part of its process. In one embodiment of the present invention prepreg member may be a dry lay-up prepreg member. A dry lay-up is a prepreg member that has been pre-fabricated prior to the vacuum bagging process. For example, a dry lay-up prepreg member may have honeycomb core structure where an aramide, aluminum metal or foam can be configured in a honeycomb shape. The honeycomb core can be introduced to several self-adhesive prepreg ply materials. The ply material can be applied to the top and bottom of the honeycomb core structure to form a prepreg honeycomb structure. The prepreg honeycomb structure can then be applied to a forming tool. In an alternative embodiment the dry lay-up prepreg member maybe formed from a fiberglass reinforcement composite material which has been partially formed or cured prior to vacuum bagging. Other reinforcement materials suitable for composite forming processes may be applied.

Typically, the reinforcement materials are arranged or oriented in a predetermined pattern to provide optimal reinforcement support to the prepreg member. Directionality of each fiber or reinforcement layer can be manipulated to increase the overall reinforcement strength of the fibers. For example, multiple layers of reinforcement cloth may be hand laid on the forming tool. The layers may be laid atop of each other in the same direction or placed atop of each other where the directionality of each cloth alternates. In an alternative embodiment the reinforcement layers may be disposed on the forming tool in a predetermined pattern via mechanical machines. In addition, the number of layers of reinforcement fibers may carefully be determined to provide the proper fiber to resin ratio.

In yet another embodiment of the present invention prepreg member 114 maybe formed from a wet lay-up process. A wet lay-up process involves applying a cloth of reinforcement fibers onto a mold. A resin (e.g. epoxy) is hand brushed or poured over the reinforcement fibers to produce an uncured prepreg member. The wet lay-up process is generally a side process which is integrated into a conventional vacuum bagging process. In accordance with the present invention prepreg member may be comprised of any reinforcement material available to one skilled in the art. For example, Kevlar®, aramide fibers, cloth, plastic fibers, foam and fiber glass, to name a few.

In yet another embodiment, a prepreg member can be formed by simultaneously spraying a mixture of reinforcement fibers and resin. The efforts of spraying a prepreg member allows for proper mixing and placement of the prepreg forming materials. Spraying the prepreg forming composition mixture of reinforcement fibers and resin produces an organized prepreg structure exhibiting increased composite strength. The resin utilized to produce the prepreg structure may be an epoxy, polyurethane, polyurea, polyester, vinyl ester or mixtures thereof. A sprayed prepreg process can be preferred over a dry lay-up process where conforming to a contoured mold surface is required. The process of creating a prepreg structure through spraying allows the applicant to apply as much or as little of the green material as needed to conform to mold surface. A sprayed prepreg process removes folds, creases or seams which may be present in a dry lay-up or hand lay-up process. In addition reduction in voids and gaps are inherently achieved through a spraying process. Although not typical, it is contemplated that in some instances the prepreg member may be applied to the system prior to the application of the sealing layer.

A second release layer 112 may also be included in an embodiment of the present invention. Utilizing a second release layer in a vacuum bagging system prevents the prepreg member from bonding or adhering to the breather/bleeder layer. The second release layer can be comprised of a fluoropolymer. In particular, the fluoropolymer can be a fluorinated polyethylene compound. However, the second release layer can vary in composition and material concentration depending on the desired application. In one embodiment the second release layer may be substituted or replace by a composition altered sealing resin compound. Altering the formulation of the sealing resin may allow the formulation to achieve characteristics and functionality of either the first or second release layer. Typically, second release layer can have a thickness in the range of about 0.01 mm to about 1 mm. In another embodiment the thickness of the second release layer 112 can be less than 0.01 mm. As with the first release layer second release layer can also be applied by hand brushing or spraying means.

In accordance with the present invention a breather/bleeder layer 110 is incorporated into the vacuum bagging process. The breather/bleeder layer provides an air or resin pathway for the air or excess resin to escape when a vacuum pressure is applied to the vacuum bag enclosure. Many skilled in the art have referred to the breather/bleeder layer as either a bleeder layer or a breather layer, inferring separate and distinct layers. In accordance with one embodiment of the present invention, the breather/bleeder layer may be separate layers. Traditionally, a bleeder layer provides an absorption area within a porous membrane material so that excess resin may be absorbed from the prepreg member during the vacuum process. When vacuum pressure is applied to vacuum bag the prepreg member secretes excess resin material from the multiple green materials which is then absorbed by the bleeder layer.

The breather layer, on the other hand, functions the same as the bleeder layer, however, the breather layer allows air to escape as a vacuum pressure is being pulled within the bagging enclosure. As mentioned and in accordance with the present invention the breather/bleeder layer means a single layer which can accomplish all of the abovementioned functions. Furthermore, the breather/bleeder layer is generally comprised of a porous or fibrous material, such as a felt type material. The material is typically about 1 mm to about 10 mm in thickness and more preferably about 3 mm to about 5 mm. Incidentally, vacuum port 104 and vacuum port aperture 102 should be in direct contact or communication with the breather/bleeder layer in order for a vacuum to remove air and thus reduce the enclosure's pressure.

In still another embodiment the breather/bleeder layer may be hand applied, brushed or sprayed. Achieving a breather/bleeder layer through a spraying technique requires spraying devices which simultaneously sprays fibers and a wetting agent, such as a resin. In a preferred embodiment the crystalline fibers receive an electrical charge prior to contact with the wetting agent. The electrical charge induces and promotes crystalline growth until contact with the wetting agent. The resultant breather/bleeder layer is formed once the formulation makes contact with the desire surface. A breather/bleeder layer formed from a spraying technique is advantageous where many protrusions and folds are present. In addition, a spraying method may alleviate any folds, creases or seams that become inherent with other hand laid processes.

Before the uncured green material is compressed and cured, vacuum layer 108 can be hand laid or disposed on the lay-up member 120 to form a vacuum enclosure. In an exemplary embodiment, the vacuum enclosure can be a vacuum film layer. Typically, tapes and adhesives may be used in conjunction with the vacuum enclosure to provide a seal around the forming tool's edges. The vacuum enclosure may comprise of materials that are non-reactive and impermeable to the green material used in the vacuum bagging system. Traditionally, a vacuum material can be comprised of any known vacuum material typically used by those skilled in the art. In particular the vacuum material is a film and can be a nylon base material. In another embodiment of the present invention a sealing layer of resin 106 may be applied to the lay-up member in lieu of a vacuum layer to form a vacuum enclosure as shown in FIG. 3. In an alternative embodiment a sealing layer of resin may be applied over a vacuum layer to enhance the sealing performance and integrity while reducing vacuum bag failure of the vacuum enclosure as depicted in FIGS. 1 and 2. In another exemplary embodiment the vacuum layer and the sealing layer may be comprised of the same resin formulation. In this embodiment the multi-layers of resin form the vacuum layer and the sealing layer.

In an exemplary embodiment of the present invention a sealing layer of resin 106 can be sprayed onto at least one component (e.g. forming tool, prepreg composite materials, vacuum layer, etc.) of the vacuum bagging system. The sealing layer may be applied over a primer material to facilitate a bond and to further enhance the sealing or vacuum integrity of the vacuum bagging system, as discussed above, and as incorporated herein. The sealing layer of resin may be a thermosetting resin having a substantially rapid cure time and high tensile strength. The resin can comprise a polyurea/polyurethane composition. The resin can be a non-reactive composition mainly comprising a) a first component comprising an aromatic or aliphatic diisocyanate prepolymer compound; and b) a second component including a chain extender and a mixture of compounds. The compounds can be selected from a group consisting of primary diamine, secondary diamine, hydroxyl terminated compounds and mixtures thereof. However, other additives may also be incorporated into the resin composition. The resin may have various applications other than vacuum bagging. For example, a thermosetting resin may be utilized in boat hull production, ballistic missile production and automotive vehicle production. The proper application of thermosetting resins depends on the formulation and additives included in the formulation, additives such as, piezoelectric material, metallic fibers, fiberglass fibers, etc.

Applying a sealing layer of resin as previously mentioned, may be accomplished or carried out through various means, such as wiping, rolling, dipping, brushing, spraying, etc. The sealing layer may be applied manually with one or more devices, with a pressurized or motor driven applicator (e.g., a spray device), or even with an automated system. Typically, the sealing resin formulation comprises two components, as discussed further herein. The two components are generally mixed together to initiate a curing reaction. The resin will usually cure within minutes of mixing, however, the curing can be slowed depending on the ratio of the components or the modification of the composition in one or more ways. Therefore application of the resin should be performed within minutes of mixing. In an exemplary embodiment, the two components are thoroughly mixed in a spraying apparatus or spray device. Spraying the sealing resin serves to promote even distribution or application of the resin material. The sealing resin mixture can subsequently be sprayed onto the forming tool, breather/bleeder layer, or vacuum bag enclosure, which enhances the seal integrity of the receiving component.

The mechanical properties of the thermosetting sealing resin can enhance the structural integrity of the composite member since the thermosetting sealing resin material is pliable yet durable enough to allow sufficient elongation which can reduce composite rupture when applied to the contours of a working surface. The inventors have discovered that these properties are conducive for vacuum bagging processes. In traditional vacuum bagging processes the vacuum film is carefully laid up around areas containing crevices, protrusions or contours. As the green material cures the vacuum film located in these areas become stressed which may make the film susceptible to vacuum or component failure. However, utilizing a sealing resin which inherently possesses some elastic characteristics can provide the process with a more secure sealing means. Therefore, a sufficient amount of sealing resin should be applied to the vacuum bagging system to provide enhanced sealing performance and to enhance sealing or vacuum integrity. In one embodiment the resin may be applied onto the vacuum bagging system at a thickness of 3 mm. In another embodiment the sealing resin may be applied at thickness greater than 3 mm. A curing time for thermosetting sealing resin 106 can be as little as 30 seconds depending on the resin formulation. A nominal curing time serves to promote a time reduction in the entire vacuum bagging process.

In still another embodiment of the present invention the sealing resin may be used to repair conventional vacuum bag enclosures. For example, the sealing resin may be applied on the surface of a reusable vacuum bag that may exhibit vacuum film tear, breakage or wear. The application of the sealing resin results in a rejuvenating sealant layer.

As illustrated in FIG. 2 a sealing layer of resin 106 can be applied to the vacuum layer 108 and breather/bleeder layer 110. FIG. 3 shows the sealing layer applied on the breather/bleeder, and preferably over a primer material, to become the vacuum enclosure. Applying the sealing layer of resin onto different components in the vacuum bagging process reduces air pockets, gaps, voids. Applying the sealing resin to vacuum layer 108 can seal the vacuum layer seams and edges, thus augmenting the integrity of the vacuum layer and reducing bag failure. In this capacity the sealing layer of resin can act as a security layer for the vacuum bagging system. Enhancing sealing performance of a vacuum bagging system reduces the time required to remove voids, gaps or air pockets and can reduce the need of quality control technicians thus significantly improving the total preparation time.

In an exemplary embodiment the thermosetting resin formulation includes a first component and a second component. The first component can be an aromatic or aliphatic diisocyanate prepolymer compound, while the second component provides a blend of primary or secondary diamine compounds and a chain extender. The diisocyanate prepolymer compound can be selected from 4,4-methylenediphenyl diisocyanate (MDI), 2,4-toluene diisocyanate (TDI), hexamethylene diisocyanate (HDI), isophorone diisocyanate (IPDI), 4,4′-dicyclohexylmethane diisocyanate (HMDI) and mixtures thereof. Generally, the diisocyanate prepolymer compound is 4,4-methylenediphenyl diisocyanate which has previously been partially polymerized with a polyol, (e.g. amine terminated or hydroxyl terminated prepolymer). The blend of primary or secondary diamine compounds of the second component are typically difunctional or trifunctional amine-terminated polyether compounds. In addition the chain extender is a diethyl toluene diamine (DETDA) compound. Moreover, the thermosetting resin can be comprised of material that is inert or non-reactive to the green material of the vacuum bagging process. The weight percentages of each component vary depending on the application. For example, in one embodiment the thermosetting resin composition may comprise about 50% in volume of the first component and 50% volume of the second component.

Applying the two component resin to a vacuum bagging system may be accomplished or carried out using any known method suitable for each intended application. For example, as discussed above, the resin may be applied by wiping, brushing, rolling, pouring, dipping, spraying or via a mechanical system or device. In an embodiment of the present invention, the resin may be sprayed through a compressed air, airless, aerosol, or robotic spraying system or device. In a specific embodiment, the resin is applied using an airless spraying system or device. In addition, the two component resin composition can be mixed upon spraying through the nozzle of a spraying gun device. In one embodiment the resin can be mixed in a pre-mixing chamber attached to the spraying device prior to being discharged from the nozzle. Traditionally, conventional spraying devices mix two component resins after discharging them from the spraying gun apparatus.

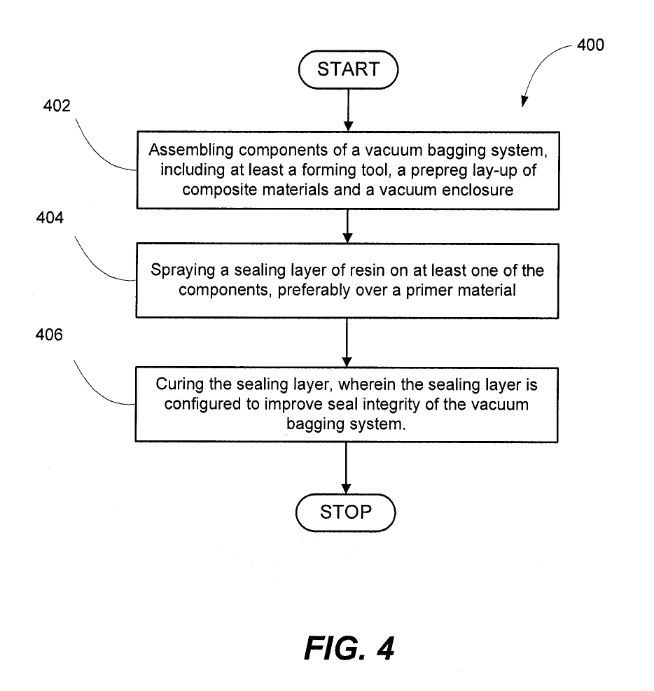

FIG. 4 illustrates a flow diagram depicting a method 400 for enhancing sealing performance of a vacuum bagging system. Accordingly, method 400 includes step 402 assembling components of a vacuum bagging system, including at least a forming tool, a prepreg lay-up of composite materials and a vacuum enclosure; step 404, applying a sealing layer of resin on at least one of the components; and step 406, curing the sealing layer, wherein the sealing layer is configured to improve seal integrity of the vacuum bagging system.

The following example illustrates at least one embodiment of the invention. However, it is to be understood that the following is only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following example provides further detail.

### EXAMPLES

A substantially flat composite member measuring four feet by four feet is formed by preparing a forming tool having a desire product shape. A release layer comprising a fluoropolymer is provided as the first release layer. The release layer is laid onto the forming tool surface. A dry prepreg lay-up member is hand placed onto the release layer ensuring all contours and voids are substantially removed. A second release layer comprising a fluoropolymer is applied to the prepreg member. Subsequently, a felt breather/bleeder layer is hand placed on the second release layer, while a vacuum film layer is disposed over the entire project. Sealing the vacuum layer over the “green” material forms the vacuum bag enclosure. The vacuum port is provided such that it is in direct contact with the breather/bleeder layer. A thermosetting resin comprising 50% w/w of polyurea and 50% w/w of polyurethane is sprayed onto the vacuum film, over a latex primer material, to provide a sealing layer thus preventing a leak or bag integrity failure. The vacuum bag system is then placed in an autoclave where the pressure inside the bag is reduced to about 20 to 30 inches of mercury, the outside pressure is increased to about 90 psi and the temperature is increased to about 350° C. The composite member is then cured and can be removed from the mold after about 2 to 4 hours in the autoclave. Once cured, the temporary bond facilitated by the primer material is caused to be released, thus allowing the vacuum enclosure to be easily removed from the forming tool.

While the invention has been described with reference to certain preferred embodiments, those skilled in the art will appreciate that various modifications, changes, omissions, and substitutions can be made without departing from the spirit of the invention. For example, other thermosetting resins, prepreg members, forming tools can also be used. It is therefore intended that the invention be limited only by the scope of the appended claims.

What is claimed is:

1. A method of vacuum bagging a composite member, comprising:
disposing a lay-up of pre-impregnated reinforcement composite materials on a forming tool;
disposing a release layer on the lay-up of pre-impregnated reinforcement composite materials;
applying a sealing layer of resin over the release layer; and
curing the sealing layer of resin.

2. The method of claim 1, wherein applying the sealing layer of resin further comprises applying the sealing layer of resin on the forming tool.

3. The method of claim 1, further comprising disposing a release layer on the forming tool.

4. The method of claim 1, wherein disposing a release layer on the lay-up of pre-impregnated reinforcement composite materials comprises hand laying.

5. The method of claim 1, wherein at least one component of the resin is selected from the group consisting of a thermosetting resin, a polymeric resin, and a thermoplastic resin.

6. The method of claim 1, wherein the resin comprises a thermosetting resin.

7. The method of claim 1, wherein the resin comprises:
a first component including an aromatic or aliphatic diisocyanate prepolymer compound; and
a second component including a chain extender and a mixture of compounds, said compounds selected from the group consisting of primary diamine, secondary diamine, hydroxyl terminated compounds and mixtures thereof.

8. The method of claim 7, wherein the diisocyanate prepolymer compound is selected from the group consisting of, 4,4-methylenediphenyl diisocyanate (MDI), 2,4-toluene diisocyanate (TDI), hexamethylene diisocyanate (HDI), isophorone diisocyanate (IPDI) and 4,4′-dicyclohexylmethane diisocyanate (HMDI).

9. The method of claim 7, wherein the diisocyanate prepolymer compound comprises 4,4-methylenediphenyl diisocyanate.

10. The method of claim 7, wherein the diisocyanate prepolymer compound is partially polymerized with a polyol.

11. The method of claim 10, wherein the polyol comprises an amine-terminated compound or a hydroxyl terminated compound.

12. The method of claim 7, wherein the blend of primary or secondary diamine compounds are amine-terminated polyether compounds having at least a functionality of 2.

13. The method of claim 2, further comprising applying a primer material to the forming tool prior to applying the sealing layer of resin on the forming tool, the primer material being configured to interact with the sealing layer of resin and the forming tool to enhance the seal integrity.

14. The method of claim 13, wherein the primer material is configured to interact with the sealing layer of resin and the forming tool by facilitating a temporary bond between the sealing layer of resin and the forming tool.

15. The method of claim 13, wherein the primer material comprises a latex based primer material.

16. The method of claim 2, wherein curing the sealing layer of resin is further configured to form an air tight enclosure.

17. A method of making a composite article, comprising:
disposing a lay-up of pre-impregnated reinforcement composite materials on a forming tool;
disposing a release layer on the lay-up of pre-impregnated reinforcement composite materials;
applying a sealing layer of resin over the release layer;
curing the sealing layer of resin;
curing the lay-up of pre-impregnated reinforcement composite materials;
removing the sealing layer of resin from the release layer;
removing the release layer from the lay-up of pre-impregnated reinforcement composite materials; and
removing the lay-up of pre-impregnated reinforcement composite materials from the forming tool.

18. A vacuum bagging system, comprising:
a forming tool;
a lay-up of pre-impregnated reinforcement composite materials on the forming tool;
a release layer on the lay-up of pre-impregnated reinforcement composite materials; and
a cured sealing layer of resin over the release layer.

19. The vacuum bagging system of claim 18, wherein the lay-up of pre-impregnated reinforcement composite materials comprises a green material.

20. The vacuum bagging system of claim 18, further comprising a release layer on the forming tool.
